(19) United States
(12) Patent Application Publication
(10) Pub. No.: US 2024/0367954 A1
(43) Pub. Date: Nov. 7, 2024

(54) Furniture jack that can be self-locking, labor-saving, and easily portable

(71) Applicant: SHENZHEN HUIKAIDA TECHNOLOGY CO., LTD, Shenzhen (CN)

(72) Inventor: He ZHANG, Guangzhou (CN)

(21) Appl. No.: 18/772,185

(22) Filed: Jul. 14, 2024

(30) Foreign Application Priority Data
Jun. 12, 2024 (CN) 202421334327.8

(51) Int. Cl. B66F 1/06

(52) U.S. Cl. CPC B66F 1/06; B66F 2700/025

(57) ABSTRACT

The present invention provides a furniture jack that can be self-locking, labor-saving and easily portable, including: the bottom plate, the bottom plate is fixed with a straight bar, the moving plate is provided on the bottom side of the bottom plate, the top of the moving plate is fixed with a shell, the internal rotation of the shell is connected with a worm. The invention provides a self-locking, labor-saving, convenient to carry, the furniture jack, driven by turning the grip of the handle and the worm, make a lever between the handle and the worm, operation, and screw mechanical structure, without relative sliding, can be stable for large objects, to increase security, and after the end of the use, to receive the grip, reduce the space to carry, improve the user experience.

### TECHNICAL FIELD

The invention relates to the field of jack technology, especially a furniture jack that can be self-locking, labor saving and easily portable.

### BACKGROUND TECHNOLOGY

Jack as a kind of lifting machinery, use is very common, size, as people demand the quality of life, the design and function of furniture is increasingly diversified, in order to meet the needs of different, furniture jack arises at the historic moment, it can help people easily adjust the height of the furniture, Angle or horizontal position, in order to get more comfortable and appropriate experience.

Existing technology of the furniture jack, most of the way of the hand, the use of friction force principle, convenient for furniture, etc., but the hand furniture jack in the use process, the lift by the part of the wrist grip, furniture and other large objects heavy rising process is very laborious, and if the object weight is greater than the friction force, may occur relatively sliding, use is not safe, the case grip the furniture jack is not normal use, cause the user use low experience, use process effort, etc.

Therefore, it is necessary to provide a kind of furniture jack that can lock, save effort, convenient to solve the above technical problems.

### INVENTION CONTENT

The present invention provides a furniture jack that can be self-locked, labor-saving and easily portable, which solves the problem of laborious furniture lifting, low security and reducing user experience.

To solve the above technical problems, the present invention provides a furniture jack that can be self-locked, labor-saving and easily portable, comprising:
Base plate, the top of the bottom plate is fixed with a straight bar;
Moving plate, the moving plate is arranged on the inner side of the bottom plate, the top of the moving plate is mounted with a shell, the inner rotation of the shell is connected with a worm, the bottom of the worm is engaged to have a vortex gear, the vortex gear is engaged to the side of the straight bar;
A ratchet handle fixing the outer side of one end of the worm having a rotation slot and the inner side of the rotation is connected with a grip.

Preferably on the side of the casing, the straight bar is provided on the inner side of the casing.

Preferably, the vortex gear rotation is connected to the inner side of the housing, and the ratchet handle is disposed on the other side of the housing.

Preferably, both sides of the bottom plate are provided with side plates, each side of the two side plates is provided with a mounting slot, the mounting slot sleeve is provided on the outer side of the bottom plate, the top of the two side plates are provided with a rotating slot, and the inner side of the rotating groove is provided with a roller.

Preferably, the inner rotation of the roller is connected with a rotating shaft, both ends of which are respectively mounted on both sides of the inner side of the rotation groove.

Preferably, the inside of the side plate is provided with a locking screw that is connected to the inside of the inner side of the bottom plate.

Preferably, the inside of the grip is provided with a sliding cavity, the inner side of the slide cavity is connected with an extension bar, and one end of the extension bar is fixed with an extension grip.

Preferably, the top and bottom of the extension rod have the finite groove of the groove, the top and bottom of the inner side of the slide cavity are fixed to the finite block, and the limit block is connected to the inner side of the limit groove.

Preferably, one end of the extension rod is fixed with a metal plate, one side of the metal plate has a magnetic plate, fixed to the other end of the inner side of the slide cavity.

Preferably, the top of the moving plate is provided with a groove, the inner side of the groove is provided with a rubber pad, the top is above the top of the moving plate.

Compared with the related techniques, a furniture jack provided by the present invention which can be self-locking, labor-saving and easily portable has the following beneficial effects:

The invention provides a self-locking, labor, convenient portable furniture jack, by rotating grip to drive the ratchet handle and worm rotation, make the lever between the ratchet handle and worm, and the operation of the worm vortex gear mechanical structure self-locking, without relative sliding, can be stable for large objects, to increase security, and after the use of the rotation, so as to receive the grip, reduce the space to carry, improve the user experience.

### ATTACHED FIGURE DESCRIPTION

FIG. 1 is a schematic diagram of the first embodiment of a furniture jack which can be self-locked, labor-saving and easily portable provided by the present invention;

FIG. 2 shows the side profile structure shown in FIG. 1;

FIG. 3 is the structural diagram of the ratchet handle shown in FIG. 1;

FIG. 4 is a schematic diagram of a second embodiment of a furniture jack which can be self-locked, labor-saving and easily portable provided by the present invention;

FIG. 5 shows the schematic of the side view structure shown in FIG. 4;

FIG. 6 is a schematic diagram of a third embodiment of a furniture jack which can be self-locked, labor-saving and easily portable provided by the present invention;

FIG. 7 is a schematic diagram of the fourth embodiment of a furniture jack which can be self-locked, labor-saving and portable provided by the present invention.

Figure label: 1, bottom plate, 11, straight bar, 2, moving plate, 21, shell, 22, groove, 23, 24, spiral gear, worm, 3, ratchet handle, 31, rotary tank, 4, handle, 5, 51, side plate, installation tank, 52, rotary groove, 53, locking screw, 54, shaft, 55, roller, 6, sliding cavity, 61, extension rod, 62, extension grip, 63, limit slot, 64, 65, metal plate, 66, magnetic plate, 7, groove, 71, rubber pad.

### Specific Implementation Methods

The present invention is further explained below in combination with the accompanying drawings and the embodiments.

### FIRST EMBODIMENT

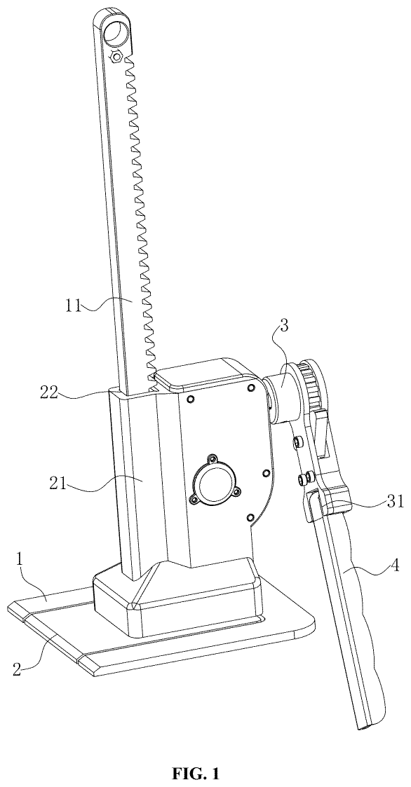

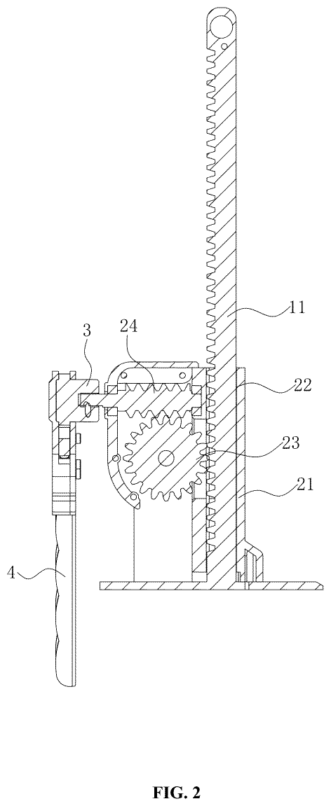

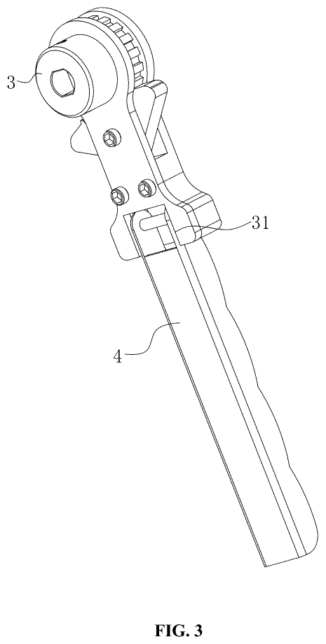

Referring to FIG. 1,2, FIG. 1 is a schematic diagram of a first embodiment of a furniture jack which can be self-locked, easily and easily carried provided by the invention; FIG. 2 is a diagram of the side profile structure shown in FIG. 1; FIG. 3 is a diagram of the ratchet handle structure shown in FIG. 1.

A furniture jack that can be self-locked, labor-saving and easily portable, comprising a bottom plate 1, the top of which is fixed with a straight rack 11;

The moving plate 2, the moving plate 2 is provided on the inner side of the bottom plate 1, the top of the moving plate 2 is fixed with the housing 2, the inner rotation of the housing 21 is connected to the worm 24, the bottom of the vortex gear 23, the vortex gear 23 is engaged on the side of the straight bar 11;

The ratchet handle 3, the outer side of one end of the worm 24, the rotation groove 31, the inner side of the rotation groove 31 is connected to the grip 4.

The inner side of the housing 21 has a chute 22, and the straight bar 11 is provided on the inner side of the chute 22.

The vortex gear 23 is rotated and connected to the inner side of the housing 1, and the ratchet handle 3 is disposed on the other side of the housing 21.

The material of the bottom plate 1 and the mobile plate 2 is stainless steel with high hardness, which can better fit the use environment ground and furniture, and the furniture jack is convenient and simple after use, which occupies small space, so as to improve the user experience;

The housing 21 is made of aluminum alloy.

The working principle of a furniture jack that is self-locking, labor-saving and easily portable provided by the present invention is as follows:

When lifting objects, The user moves the base 1 and the moving plate 2 to the bottom of the furniture, Then the worm 24 is rotated by shaking the ratchet handle 3, When a lever is formed between the ratchet handle 3 and the worm 24, The user is very easy in the operation, Then, the vortex gear 23 is rotated by the worm 24, Thus engaging the vortex gear 23 and the straight rack 11, Thus driving the housing 21 to move upward, And so that the housing 21 drives the moving plate 2 to move upward, To lift the bottom of the furniture, And the self-locking of the worm 24, The relative sliding does not occur, You can steadily lift and lift medium and large objects, Very safe, After the end of the use, The user can turn the grip 4, Thus turning the grip 4 on the inner side of the rotation groove 31, Then fold it back to the grip 4, Thus reducing the footprint.

Compared with the related techniques, a furniture jack provided by the present invention which can be self-locking, labor-saving and easily portable has the following beneficial effects:

By turning the grip 4, the ratchet handle 3 and the worm 24, the lever between the ratchet handle 3 and the worm 24, and the mechanical structure of the vortex gear 23 in the lifting process increases the sliding, increasing the safety of the grip 4, thus reducing the handgrip, and improving the user experience.

### SECOND EMBODIMENT

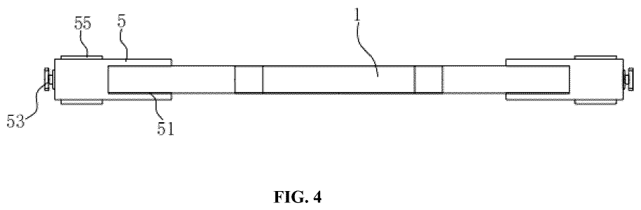

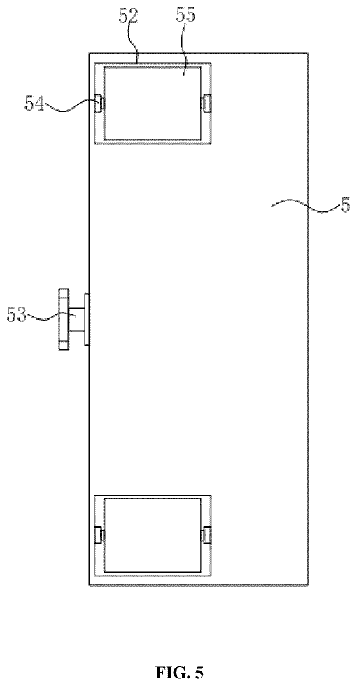

Referring to FIG. 4 and FIG. 5, based on a furniture jack capable of self-locking, labor-saving and portable provided by the first embodiment of this application, the second embodiment of this application proposes another furniture jack that can be self-locking, labor-saving and portable. The second embodiment is only a preferred mode of the first embodiment, and the implementation of the second embodiment will not affect the separate implementation of the first embodiment.

Specifically, the second embodiment of the present application provides the difference of a furniture jack, a side jack with the side plate 5 on both sides of the side plate 5, the mounting slot 51 set on the outer side of the bottom plate 1, the two side plates 5 at both ends of the top of the side slot 52, the inner sides of the rotation groove 52 are provided with a roller wheel 55.

The inner rotation of the roller 55 is connected with a rotation shaft 54, both ends of which are respectively mounted on both sides of the inner side of the rotation groove 52.

The side plate 5 is provided with a locking screw 53, one end of which is connected to the inside of the inner side of the bottom plate 1.

When mounting, the mounting groove 51 is provided on the outer side of the bottom plate 1, and the thread of one end of the locking screw 53 is connected to the interior of the side of the bottom plate 1 to mount the side plate 5;

By mounting the rotating shaft 54 and the roller 55 on the inner side of the rotation groove 52, the height of the top of the roller 55 is reduced so that the furniture can be lifted into a smaller space.

The working principle of a furniture jack that is self-locking, labor-saving and easily portable provided by the present invention is as follows:

At the time of its use, When the furniture needs to be lifted and then moved, The user may mount the side plate 5 on both sides of the bottom plate 1, Thus, the two sides of the bottom plate 1 are stuck on the inner sides of the mounting slot 51, Then the user turns the locking screw 53, To thread one end of the locking screw 53 to the inside of the side of the bottom plate 1, Thus installing the side plate 5, After placing the substrate plate 1 on the ground, Now the roller 55 will make contact with the ground, During the subsequent movement, Move upward by moving the plate 2, After lifting the furniture, Rolling on the ground by the roller 55, Convenient for users to adjust the position of the furniture.

Compared with the related techniques, a furniture jack provided by the present invention which can be self-locking, labor-saving and easily portable has the following beneficial effects:

With the side plate 5, the locking screw 53, the rotating shaft 54, and the roller 55, when it is necessary to move the furniture, the side plate 5 can be mounted on both sides of the bottom plate 1, contacted between the wheel 55 and the ground, and then rolled through the roller 55 to facilitate the user to move the position of the furniture, so as to increase the adaptability and diversity of the device.

### THE THIRD EMBODIMENT

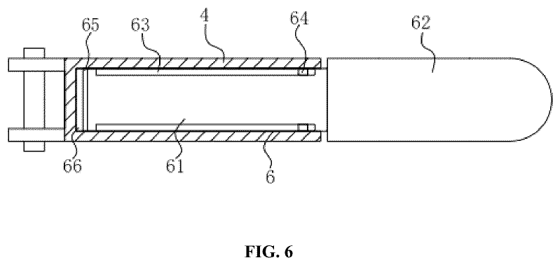

Referring to FIG. 6, on the basis of a furniture jack that can be self-locked, labor-saving and easy to be carried as provided by the first embodiment of the present application, the third embodiment of the present application proposes another furniture jack that can be self-locked, labor-saving and easy to be carried. The third embodiment is only a preferred mode of the first embodiment, and the implementation of the third embodiment will not affect the separate implementation of the first embodiment.

Specifically, according to the third embodiment of the present application, the opening of a furniture jack, a jack 4 has a sliding cavity 6, an extension grip 61 is attached at one end of the extension bar 61.

The finite slot 63 is provided to the top and bottom of the extension rod 61, the finite block 64 is fixed to the upper side and the lower side, and the limit block 64 is attached to the inner side of the limit slot 63.

The extension rod 61 is fixed to one end of a metal plate 65 with a magnetic plate 66 fixed to the other end of the inner side of the slide cavity 6.

When the extension rod 61 is received to the inner side of the cavity 6, the metal plate 65 and the magnetic plate 66 are magnetically attracted to limit the extension rod 61 and avoid the extension rod 61 sliding out from the inner side of the cavity 6 when not in use;

The length of the extension bar 61 is slightly shorter than the length of the grip 4, and the length of the extension grip 62 is slightly longer than the length of the grip 4, so the extension bar 61 is pulled within the length of the cavity 6, thus allowing the staff to operate more effort.

The working principle of a furniture jack that is self-locking, labor-saving and easily portable provided by the present invention is as follows:

For use, when the overall length of the handle is required, the user can pull the extension handle 62 to drive the extension handle 62 to the inner side of the extension lever 61 and the limit block 64 slides on the inner side 63 to the limit slot 63 to limit the extension handle 61, after which the user can rotate the handle 3 to increase the length of the handle and facilitate the user operation.

Compared with the related techniques, a furniture jack provided by the present invention which can be self-locking, labor-saving and easily portable has the following beneficial effects:

By means of the sliding cavity 6, the extension bar 61, the extension grip 62, the limit slot 63, the limit block 64, the metal plate 65 and the magnetic plate 66, they pull the extension grip 62 on the inner side of the sliding cavity 6, thereby increasing the overall length of the handle and allowing the user to rotate more easily.

### THE FOURTH EMBODIMENT

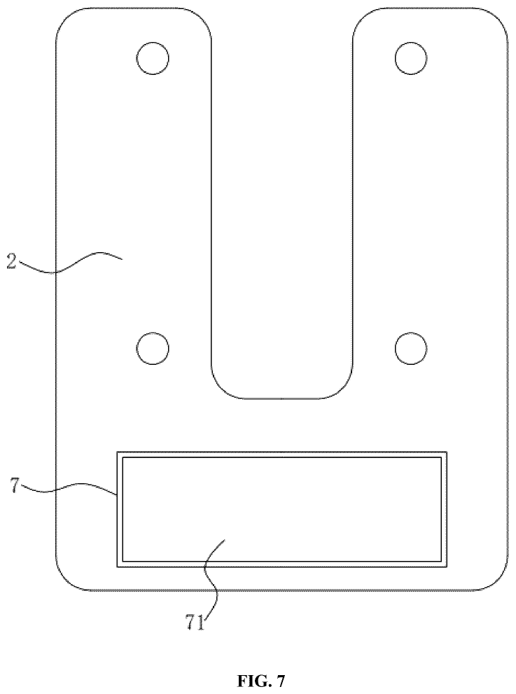

Referring to FIG. 7, based on a furniture jack capable of self-locking, labor-saving and portable provided in the first embodiment of the present application, the fourth embodiment of this application proposes another jack of furniture that can be self-locking, labor-saving and portable. The fourth embodiment is only a preferred mode of the first embodiment, and the implementation of the fourth embodiment will not affect the separate implementation of the first embodiment.

Specifically, according to the fourth embodiment of the present application, the difference of a furniture jack is that a furniture jack, the movable plate 2 is provided with a groove 7, the adhesive pad 71, and the top of the adhesive pad 71 is above the top of the movable plate 2.

The working principle of a furniture jack that is self-locking, labor-saving and easily portable provided by the present invention is as follows:

In the process of use, when the moving plate 2 pushes the furniture upward, the user may place the rubber pad 71 into the inner side of the groove 7, thus contacting the top of the rubber pad 71 and the bottom of the furniture, thus avoiding the moving plate 2 in direct contact with the furniture.

By placing the adhesive pad 71 into the inner side of the groove 7, the groove 7 can limit the adhesive pad 71 in the process of use.

Compared with the related techniques, a furniture jack provided by the present invention which can be self-locking, labor-saving and easily portable has the following beneficial effects:

Through the grooves 7 and the rubber pad 71, the adhesive pad 71 is placed into the inner side of the groove 7 for the upward movement of the furniture by the moving plate 2 to contact the bottom of the furniture with the rubber pad 71 and avoid the wear of the furniture bottom caused by the moving plate 2 and the protection of the furniture.

The above mentioned are only embodiments of the invention and do not thus limit the patent scope of the invention. All the equivalent structure or equivalent process transformations made by the invention description and the contents of the attached drawings, or directly or indirectly applied in other relevant technical fields, are similarly included in the scope of patent protection of the invention.

What is claimed is:

1. A furniture jack that can be self-locking, labor-saving and easily portable, its characteristics are, including:
Base plate, the top of the bottom plate is fixed with a straight bar;
Moving plate, the moving plate is arranged on the inner side of the bottom plate, the top of the moving plate is mounted with a shell, the inner rotation of the shell is connected with a worm, the bottom of the worm is engaged to have a vortex gear, the vortex gear is engaged to the side of the straight bar;
A ratchet handle fixing the outer side of one end of the worm having a rotation slot and the inner side of the rotation is connected with a grip.

2. A furniture jack that can be self-locking, labor-saving and easily portable according to claim 1, wherein the side of the casing is provided and the straight bar is provided on the inner side of the casing.

3. A furniture jack that can be self-locking, labor-saving and easily portable according to claim 1, wherein the vortex gear is connected to the inner side of the housing and the ratchet handle is disposed on the other side of the housing.

4. A furniture jack that can be self-locking, labor-saving and easily portable according to claim 1, which is self-locking, labor-saving and convenient, the bottom plate is provided with a side plate, the side of the side plate has an installation slot, the outer side of the bottom plate has a rotating slot, and the inner side of the roller.

5. A furniture jack that can be self-locking, labor-saving and easily portable according to claim 4, wherein the inner rotation of the roller is connected with a rotating shaft, and the two ends of the rotating shaft are respectively mounted on two sides of the inner side of the rotating groove.

6. A furniture jack that can be self-locking, labor-saving and easily portable according to claim 1, wherein the interior of the side plate is provided with a locking screw, and one end of the locking screw is connected to the interior of the inner side of the bottom plate.

7. A furniture jack that can be self-locking, labor-saving and easily portable according to claim 1, wherein the grip is provided with a sliding cavity, a sliding side of the sliding cavity is connected with an extension bar, and one end of the extension bar is fixed with an extension grip.

8. A furniture jack that can be self-locking, labor-saving and easily portable according to claim 7, wherein a finite slot is provided at the top and bottom of the extension bar, the finite end of the top and the bottom side of the sliding cavity are fixed to the finite block, and the limit block is connected to the inner side of the limit slot.

9. A furniture jack that can be self-locking, labor-saving and easily portable according to claim 1, wherein the extension bar is fixed to one end with a metal plate, one side of the metal plate has a magnetic plate, and the magnetic plate is fixed to the other end of the inner side of the sliding cavity.

10. A furniture jack that can be self-locking, labor-saving and easily portable according to claim 1, wherein the top of the moving panel has a groove, and the inner side of the groove is provided with a rubber pad, and the top of the rubber pad is above the top of the moving plate.
